(19) United States
(12) Patent Application Publication
(10) Pub. No.: US 2018/0208480 A1
(43) Pub. Date: Jul. 26, 2018

(54) SEAWATER INJECTION CONTROL METHODS AND SYSTEMS

(71) Applicant: Vetco Gray Scandinavia AS, Sandvika (NO)

(72) Inventor: Sudhir Trambakrao CHAMBHARE, Oslo (NO)

(21) Appl. No.: 15/745,160

(22) PCT Filed: Jul. 15, 2016
(86) PCT No.: PCT/EP2016/066935

§ 371 Date: Jan. 16, 2018

(30) Foreign Application Priority Data
Jul. 18, 2015 (NO) 20150956

(51) Int. Cl. C02F 1/00; C02F 1/44; C02F 9/00; E21B 43/20; B01D 61/02; B01D 61/14; B01D 61/22; B01D 61/58; B01D 65/02

(52) U.S. Cl. CPC C02F 1/008; C02F 2103/08; C02F 1/442; C02F 1/444; C02F 9/00; E21B 43/20; B01D 61/022; B01D 61/025; B01D 61/027; B01D 61/142; B01D 61/145; B01D 61/22; B01D 61/58; B01D 65/022; B01D 2311/165; B01D 2315/20; B01D 2321/04; C02F 1/441

(57) ABSTRACT

A control method and system for controlling the operation of a seawater injection system comprising at least one water treatment line in which seawater is forced through one or more coarse filtration unit(s), ultrafiltration unit(s) and at least one of a reverse osmosis unit and/or a nanofiltration unit to a water injection pump, and wherein the flowrate required to create differential pressure across membrane(s) of the ultrafiltration unit(s) is obtained by a boosting pump. A controller “C” implemented operation control is applied to adjust automatically the outlet pressure and flow of the boosting pump such that an average flowrate through the ultrafiltration units is maintained and determined as boosting pump flow divided by the number of active ultrafiltration units. A proportional-integral-derivative control mechanism is preferably applied to all adjustable flow/pressure regulating units in the seawater injection system.

### BACKGROUND OF THE INVENTION

The present invention relates to a control method and a system for injection of seawater into a hydrocarbon containing subterranean formation. To be more specific the invention relates to a method and a system for controlling the operation of a seawater injection system which comprises at least one water treatment line in which seawater is forced through one or more coarse filtration units, ultrafiltration units and at least one of a reverse osmosis unit and a nanofiltration unit to a water injection pump, and wherein the flowrate required to create differential pressure across membranes of the ultrafiltration units is obtained by a boosting pump.

In hydrocarbon production injection of water in oil or gas containing subterranean formations is a widely used method to assist in the recovery of hydrocarbon products by raising the pressure in the formation and in this way prolonging the productive life of an oil or gas production field. In subsea production seawater is typically used for injection. Due to its content of biological matter, sand and salt etc., raw seawater is however less suitable for injection and requires processing before injection. Processing seawater into water suitable for injection purposes can include different stages of filtration, desalination and disinfection.

A method of producing injection water from seawater is previously known from U.S. Pat. No. 7,600,567 B2 (Christopher et al). The method disclosed in U.S. Pat. No. 7,600,567 B2 includes dosing of chemical concentrates and desalination through reverse osmosis. A submerged reverse osmosis assembly comprises a coarse filtration unit and a fine filtration unit arranged sequentially upstream of the reverse osmosis unit. The coarse filtration unit may be arranged as a strainer and the fine filtration unit may comprise a plurality of hollow fibre membranes. The specification mentions a submerged reverse osmosis assembly comprising a cleaning system for removing fouling material from the retentate side of the membranes of fine filtration units, for example, the membranes may be flushed with a portion of low salinity water at periodic intervals. In U.S. Pat. No. 7,600,567 B2 the reverse osmosis assembly is powered through a subsea electric cable, and fibre optic cables are suggested for data and video transmission. Otherwise the document is unspecific with regards to the operational control of the submerged reverse osmosis assembly.

### SUMMARY OF THE INVENTION

One aspect the present invention aims to provide a method for operation of a seawater injection system that includes a high degree of auto-control and continuity in production. A seawater injection system designed for implementation of the method is another and related aspect of the invention.

An object of the invention as of the first aspect is met by a method as described initially, wherein a controller implemented operation control is arranged to adjust automatically the outlet pressure and flow of the boosting pump such that an average flowrate through the ultrafiltration units is maintained and determined as boosting pump flow divided by the number (N) of active ultrafiltration units.

In an embodiment a proportional-integral-derivative (PID) control mechanism is applied and executed by the controller for regulation of the output flow/pressure from any flow regulating unit in the seawater injection system, including but not limited to the boosting pump, the water injection pump and valves. As used herein the expression “control mechanism” shall be understood to comprise controller generated commands for dedicated electrical, mechanical and electro-mechanical components involved in the regulation of flow and/or pressure according to rules and algorithms which are implemented in the controller and upon which these commands are based. Examples of commands generated by the controller are valve adjustment commands and current or frequency changing commands for pumps and variable frequency (VFD) or variable speed (VSD) drives e.g.

Ultrafiltration, nanofiltration and reverse osmosis are types of membrane filtration processes in which hydrostatic pressure forces water against a semipermeable membrane capable of separating out substances from the water, mainly through size exclusion. Ultrafiltration is not principally different from the other types of membrane filtration processes except in terms of the size of the pores and the size of molecules it retains. In general terms the pore size or particle size removal capacity of ultrafiltration membranes range from 0.005 to 0.1 micron, whereas the nanofiltration membranes range from 0.001 to 0.01 micron and the reverse osmosis membranes are capable of excluding particle sizes ranging down to 0.0001 micron.

The filter membranes and filter units applied in the method and system of an embodiment of the present invention are not limited to the exact figures and ranges mentioned here, but are introduced merely as a general illustration of the different stages of filtration which can be applied in the process of preparing injection water from raw seawater.

In contrast to the reverse osmosis filters, wherein substances which cannot pass the membrane are automatically diverted to a waste drain, the ultrafiltration filters require frequent removal of material that builds up on the retentate side of the membrane. Conventionally during a halt in the process, the ultrafiltration membranes are backflushed with permeate water from the ultrafiltration unit or from any of the downstream located nanofiltration or reverse osmosis units.

In the seawater injection method and system of an embodiment of the present invention a boosting pump is controlled to generate the flowrate required to create differential pressure across membrane(s) of a number of ultrafiltration units arranged in the water treatment line. If a backwash sequence is initiated in any of the ultrafiltration units, the average flow rate through the active ultrafiltration units can be automatically maintained by proportional adjustment of the booster pump flow and pressure or recycle the permeate flow from spare ultrafiltration unit, which can be operated in alternate sequences. In other words the water treatment process continues without stops for cleaning the ultrafiltration membranes.

The outlet pressure and flow from the boosting pump is adjusted by the controller through a closed loop feedback control wherein the difference between a predetermined flow set point and the measured actual flow determines the amount of regulation of a control valve controlling the output flow from the boosting pump. In an embodiment the difference between desired and actual flows is regarded as an error which is adjusted to constitute the weighted sum of the present error, the accumulated past errors and the predicted future errors based on current range of change through a proportional-integral-derivative control mechanism (PID-control).

More precisely, a PID control mechanism can be applied to all adjustable flow regulating valves on flow lines and pumps in the seawater injection system.

The demand for backwash of membranes is checked in a closed control loop and a backwash sequence of limited duration is generated on each ultrafiltration unit if backwash is required. Backwash of ultrafiltration membranes can be required for any of a number of checked conditions. Among the monitored conditions of special interest are for example: the chlorine concentration which should stay below acceptable limits; a scheduled backwash sequence that is currently under process; since the membrane's integrity must not be compromised backwash sequence will be initiated upon detecting high transmembrane pressure across any of the respective ultrafiltration units.

A start-up sequence of the seawater injection system comprises the following steps performed by the control method starting seawater filtration units and boosting pump in manual mode; checking backwash conditions, and if backwash conditions are met; transferring seawater filtration units and boosting pump into auto mode applying a proportional-integral-derivative control mechanism to maintain flowrate and pressure in the boosting pump.

In closer detail the seawater injection system can be set in operation through a number of sequentially performed steps, see the flow charts of the accompanying drawings of FIGS. 4-6 as non-limited examples to the present invention.

Step 1: feed set points for process parameters such as water injection flow, backwash flow, pumps flow and alarms to the controller; activate auxiliary electric/electronic and monitoring systems; enable protection functions for pumps and membranes (PDT) etc.

Step 2: start seawater filtration units and boosting pump in MANUAL mode; open start-up line On/Off valve.

Step 3: ramp up the boosting pump speed.

Step 4: open the backwash control and On/Off valves.

Step 5: read seawater injection process sensors and report data to the controller, including values of pressure, temperature, flow, chlorine and turbidity.

Step 6: check that boosting pump minimum speed is achieved, if NO return to step 3, if YES proceed to Step 7.

Step 7: close start-up line On/Off valve.

Step 8: check if backwash conditions are met: if NO start backwash sequence by opening the appropriate backwash valves and perform backwash sequence (with chlorine and water respectively) for 1 minute on each UF unit; if YES proceed to Step 9.

Step 9: consider boosting pump outlet pressure/flow set points and switch boosting pump into AUTO mode: run PID control mechanism in the controller.

Step 10: distribute and maintain average flow through each ultrafiltration unit automatically, applying the average flowrate as boosting pump flow divided by the number (N) of active ultrafiltration units; select ultrafiltration unit's control valves in AUTO mode: run PID control mechanism in the controller.

The backwash condition check in step 8 may comprise a control that the chlorine concentration is within acceptable limits, or a check that a scheduled timer of 1 hour is finished/inactive, or in the case of a transmembrane pressure high-high trip on any ultrafiltration unit, to initiate an immediate stop of that unit and compensate flow rates through other ultrafiltration units to meet the boosting pump flow set point or to activate the spare UF unit to maintain the constant flow.

In AUTO mode the boosting pump speed can be maintained at the set point through a closed loop control illustrated as Step 11 in FIG. 5, including monitoring and regulation of the pump speed through a PID control mechanism.

Injection of water is controlled to commence according to the following sequence: starting the water injection pump in manual mode; checking injection water quality, and if the quality of injection water is met; transferring injection pump into auto mode applying a proportional-integral-derivative control mechanism to maintain flowrate and pressure in the injection pump.

If excessive water is produced in the seawater filtration units and not used for injection, the excessive water can be disposed of by returning to the sea.

In closer detail, seawater injection according to an embodiment of the present invention involves the further steps illustrated in the accompanying flow chart of FIG. 6.

Step 12: activate the reverse osmosis and nanofiltration units; open reject and permeate line valves of the reverse osmosis and nanofiltration units, open reject line control valves.

Step 13: consider flowrate set points; start water injection pump in MANUAL mode.

Step 14: ramp up water injection pump speed.

Step 15: read seawater injection process sensors and report data to the controller, including values of pressure, temperature, flow, chlorine and turbidity.

Step 16: check that water injection pump minimum speed is achieved, if NO return to step 14 if YES proceed to step 17.

Step 17: check that treated water meets injection water quality; if NO open permeate control valve on the nanofiltration unit for mixing in water from the nanofiltration unit with the permeate from the reverse osmosis unit; if YES proceed to Step 18.

Step 18: switch water injection pump into AUTO mode.

Step 19: check that required flowrate/pressure is maintained in the water injection pump: if NO increase pump speed by applying the PID control mechanism in a closed control loop; if YES proceed to Step 20 at which all control valves are maintained in AUTO mode and all protection functions are enabled.

In analogy with the aforesaid a second aspect of the present invention relates to a control system for a seawater injection system comprising at least one water treatment line in which seawater is forced through one or more coarse filtration unit(s), ultrafiltration units and at least one of a reverse osmosis unit and a nanofiltration unit to a water injection pump, and wherein the flowrate required to create differential pressure across membrane(s) of the ultrafiltration units is obtained by a boosting pump. The units and pumps of the seawater injection system are electronically integrated in a controller implemented operation control by which the outlet pressure and flow of the boosting pump is automatically adjusted such that an average flowrate through the ultrafiltration units is maintained and determined as boosting pump flow divided by the number (N) of active ultrafiltration units.

In an embodiment of the control system the controller is arranged for execution of a PID control mechanism for regulation of the output flow/pressure from at least one of the boosting pump, the water injection pump and valve.

In an embodiment the control system further comprises; a closed control loop for checking backwash conditions; a closed control loop applying a proportional-integral-derivative control mechanism to maintain flowrate and pressure in the boosting pump; a closed control loop applying a proportional-integral-derivative control mechanism to maintain flowrate and pressure in the injection pump.

In an embodiment the control system further comprises a closed control loop applying a proportional-integral-derivative control mechanism to maintain flowrate through backwash flow control valve(s), permeate flow control valve(s), and reject flow control valve(s).

The PID control mechanism can be applied to all adjustable flow regulating valves in the seawater injection system.

The controller implemented operation control may be integrated in a control module that controls the position of flow control valves and power supply to pumps and other seawater injection units in response to detected flow and/or temperature and/or pressure and/or water quality in the water flow through the seawater treatment line(s).

The control module may further be part of a master control station located topside, or is a subsea control module and/or subsea electronic module communicating with the master control station via an umbilical.

The control system may further include a computer based application to record the seawater injection system component's performance stored in a memory wherein operational conditions and control measures are continuously recorded as historical data to provide a basis for logic/rules to be applied to compare and evaluate the real-time data with ideal conditions and to make decision for diagnosis and maintenance.

### BRIEF DESCRIPTION OF THE DRAWINGS

The details of the present invention will now be further illustrated and explained with reference made to the accompanying drawings. In the drawings,

FIG. 1 is a schematic illustration of a seawater injection system to which the control method and control system of the invention can be applied,

FIG. 2 is a block diagram illustrating a closed loop control mechanism applied for regulation of a flow control valve in the seawater injection system,

FIG. 3 is a graph illustrating the effect on seawater flow from the closed loop control mechanism applied to the control valve, and

FIGS. 4-6 are flow charts illustrating the control method in sequential steps.

### DETAILED DESCRIPTION

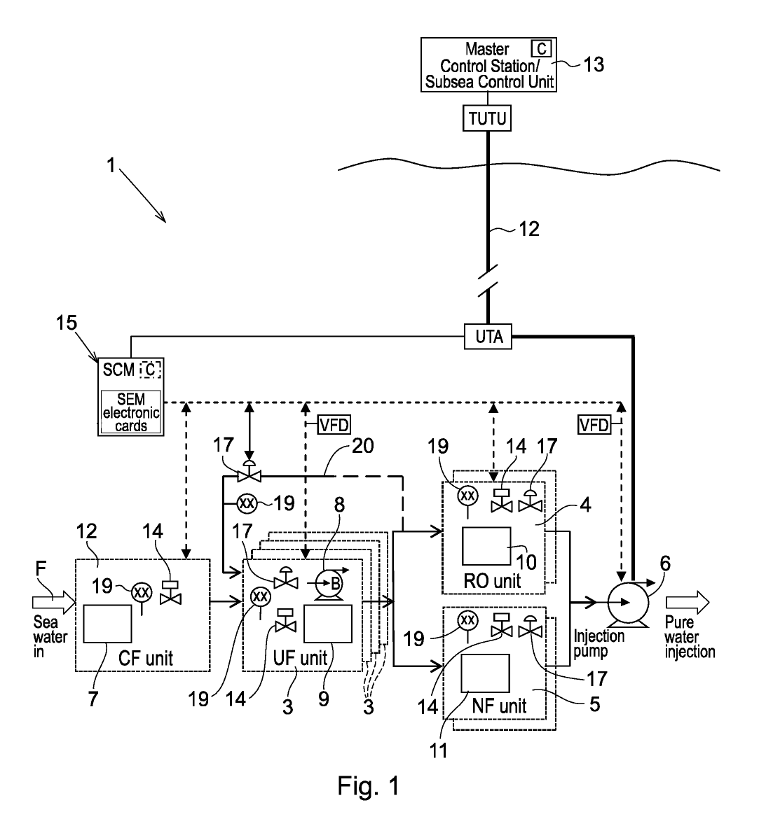

With reference to FIG. 1 a seawater treatment line in a submerged seawater injection system 1 comprises one or more coarse filtration units 2, one or more ultrafiltration units 3, one or more reverse osmosis units 4 and one or more nanofiltration units 5. The filtration units 2-5 are arranged in succession upstream of a seawater injection pump 6 as seen in the flow direction F of seawater through the seawater injection system 1. Flow lines in FIG. 1 illustrate how the permeate water from the ultrafiltration unit 3 can be delivered to any or both of the nanofiltration and reverse osmosis units. Flow lines in FIG. 1 further illustrate that the permeate outflows from the nanofiltration and reverse osmosis units can be mixed upstream of the injection pump 6.

The coarse filtration unit 2 may comprise a strainer element 7 designed for sorting out solid particles and organisms from raw seawater. The strainer 7 can be configured with a pore size ranging from about 1-100 micron, e.g. A boosting pump 8 provides sufficient pressure and flow to generate the hydrostatic pressure that is required over semipermeable membranes 9, 10 and 11 in the ultrafiltration, nanofiltration and reverse osmosis units respectively. The pore sizes of the membranes 9-11 can be substantially as discussed above.

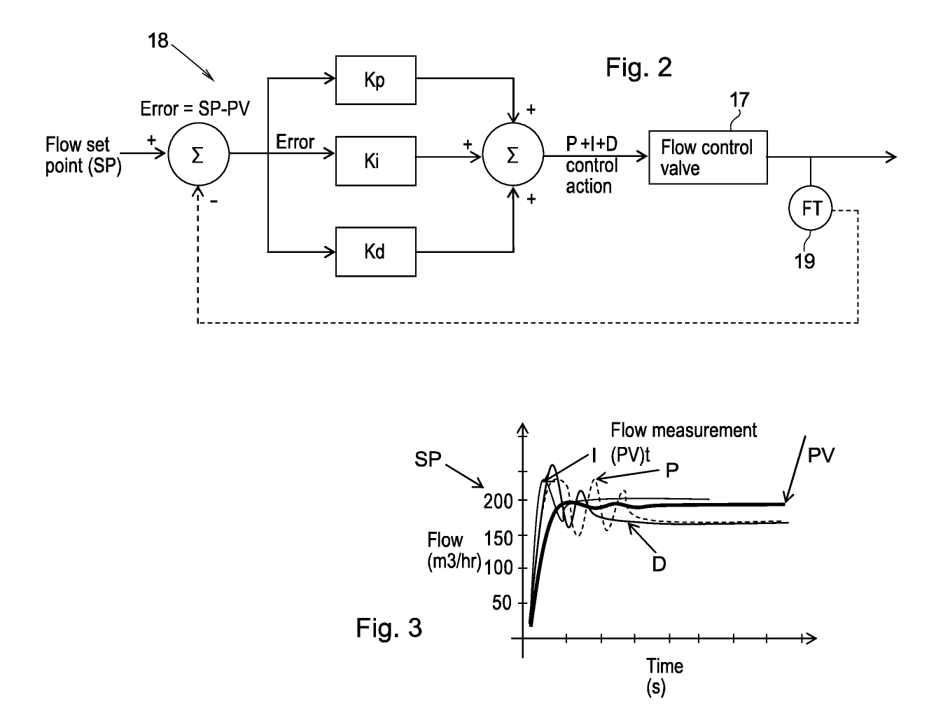

The operation of the seawater injection system 1 is powered and initiated via the umbilical 12 from a topside master control station 13. At start-up of the system, power switches and On/Off valves 14 are manually activated from the topside control station 13. Once in operation, the control of the seawater injection system 1 is switched into auto mode and maintained at a steady operational state through a feedback control. The feedback control is performed in the electronic controller “C” located in the subsea control module 15 or in the topside Master Control Station 13, which is configured to run a controller implemented control software. Based on comparison between actual and desired flow and/or pressure the controller “C” generates control signals and/or power commands to variable frequency drives (VFD) or variable speed drives (VSD) for boosting and injection pumps, as well as setting commands to the actuators of control valves 17 that regulate the flowrate/pressure in the seawater flow through filtration units and pumps. More precisely, the setting of each flow control valve 17 and/or the regulation of each VSD/VFD can be controlled by a dedicated closed control loop as illustrated in FIG. 2.

The closed control loop illustrated in FIG. 2 comprises a proportional-integral-derivative (PID) control mechanism 18 which is run by the controller “C” for regulation of the flowrate through the subject flow control valve 17. The amount of regulation of the valve is based on actual output flow, detected by flow or pressure transmitters 19 (see symbol FT in FIG. 2), in relation to a desired flowrate or set point (SP) used as input to the PID control mechanism. The seawater injection system 1 comprises dedicated PID control of the flow through ultrafiltration units, boosting pumps, injection pumps, reverse osmosis units, nanofiltration units and backwash lines. The PID control mechanism is based on the following general algorithm where u(t) is the control action required to reach the set point
Kp is the proportional gain constant

$$u ( t ) = {Kp}^{*} e ( t ) + Ki {\int }_{O}^{t} e ( τ ) dt + Kd \frac{d}{dt} {}^{*} e ( t )$$

Ki is the integral gain constant
Kd is the derivative gain constant
e is the error (difference between process value and set point value)
t is the time constant (instantaneous)
τ is the integral time constant (time interval “0” to present t)

### Example

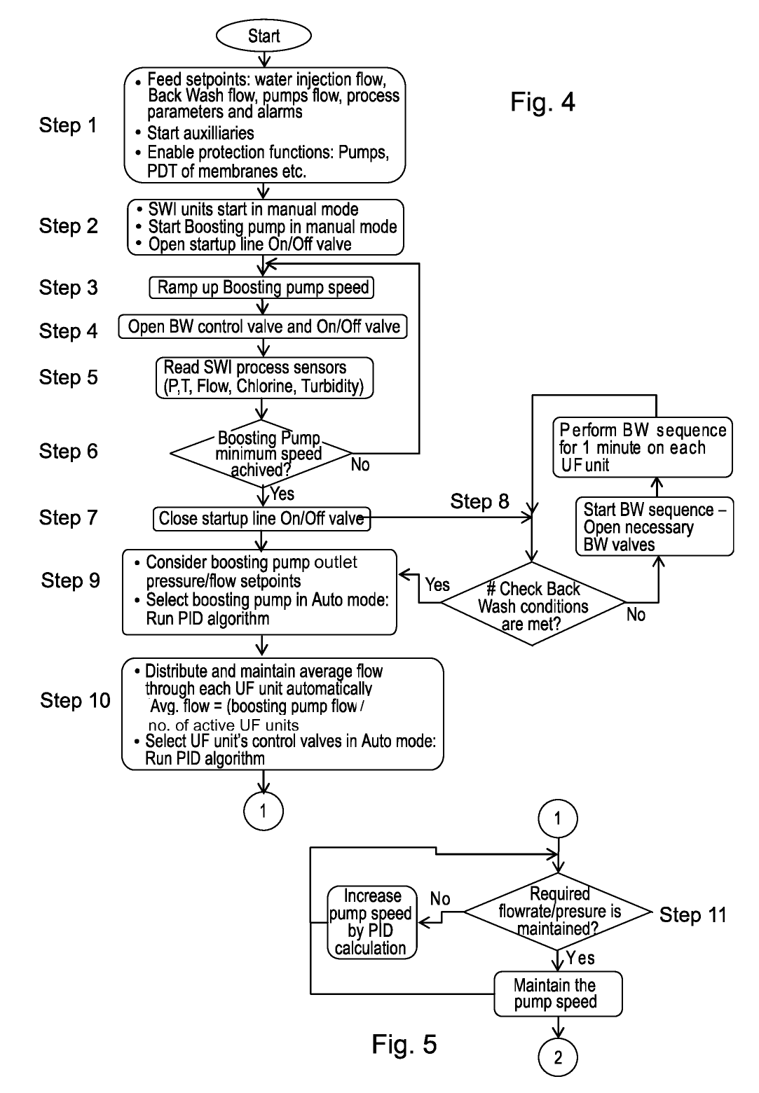

The effect on valve control and flow is illustrated in the graph of FIG. 3 for a given flow. In this example a flow of 200 m³/h (SP) was desired to operate a pump within its specified envelope. The PID control mechanism was tuned by giving different weights to the parameter constants: the Proportional gain constant (designated P in the graph) was given the value of 3.0, the Integral gain constant (I) was given the value of 1.5, and the Derivative gain constant (D) was given the value of 0.05. At a control output percentage of 64.52 to 65.75%, the actual flow (PV) was stabilized at a flowrate of 198.99 to 201.11 m³/h by the PID control mechanism.

The invention is of course not limited to the values of the illustrated example; other flows and parameter settings may need to be applied in other implementations and at other operational conditions. For example, considering the span in the weights allotted to the PID parameters, the derivative portion may under certain conditions be omitted and the electronic controller “C” would in such case be executing a PI control on the flow or pressure. The/three parameter/PID control of the recited example is however presently regarded as constituting the best mode of operation, notwithstanding the fact that a skilled person will realize that the benefits of the invention would still substantially be achieved also if the derivative portion was left out. Thus, the expression PID control mechanism as used in the disclosure and claims shall be construed to include also the PI control embodiment.

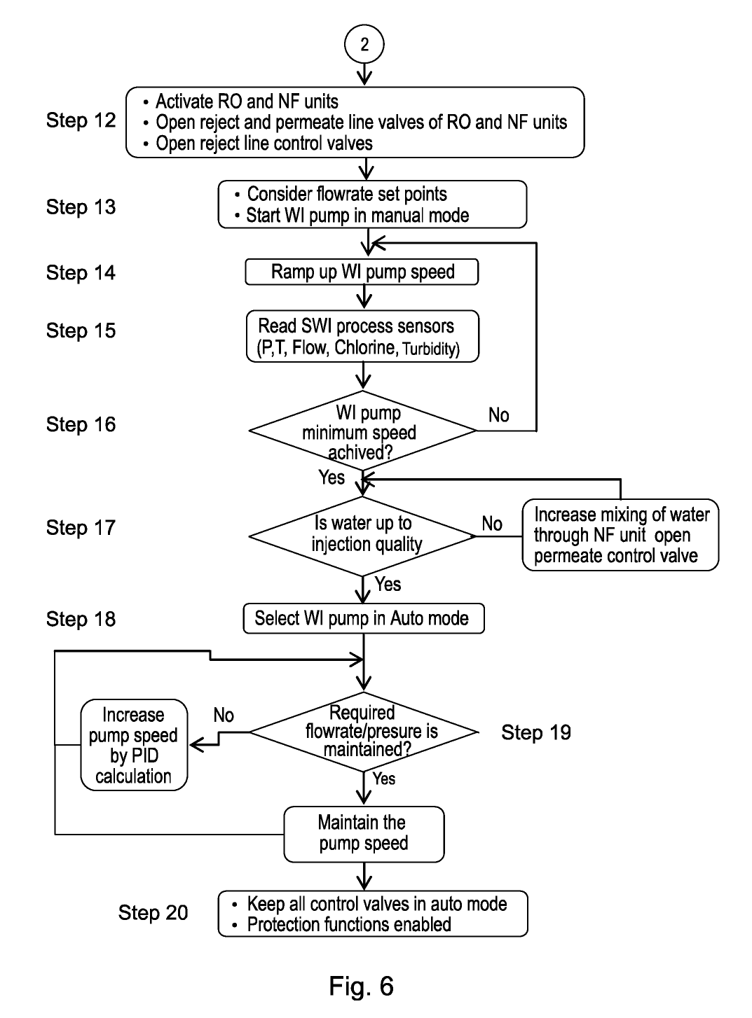

The sequential steps of the control method, from manual start-up to auto mode steady state operation, are illustrated in the drawings of FIGS. 4-6. In the method, process parameters such as injection rate, backwash flowrate, pumps flowrate and alarms etc., are set by the operator during configuration of the control system, and is then maintained by the controller “C”.

However, since the drawings are self-explanatory and the method has already been described with reference to the drawings in the Summary of Invention, these drawings will not be repeatedly discussed in this part of the disclosure.

With reference to FIG. 1 again the seawater injection system 1 comprises a facility for cleaning the membranes 9 of the ultrafiltration unit/stage 3. To this purpose a backwash line 20 is arranged to flush the retentate side of the ultrafiltration membrane with permeate water extracted from the treated water flow through the seawater injection system. The flow in the backwash line 20 is controlled by the controller “C”, an adjustable flow control valve 17. This backwash sequence is applied to each UF unit by operating set of on/off valves 14, controlled by the controller “C” automatically. A PID control mechanism may be applied in the controller for adjusting the control valve and regulating the flow in the backwash line 20 based on a predetermined desired backwash flow (SP) and readings (by flow or pressure transmitter 19) of the actual output flow downstream of the control valve 17 in the backwash line 20.

The backwash water can alternatively be extracted from the permeate water that is discharged from the nanofiltration unit 5, or can alternatively be taken from the low salinity permeate delivered by the reverse osmosis unit 4. The backwash water may alternatively be extracted from the permeate water discharged from other ultrafiltration units that are arranged in a parallel configuration in the water treatment line of the seawater injection system 1. Arranging a set of ultrafiltration units to operate in parallel as indicated by hatched lines in FIG. 1 provides the advantage of continued operation of the seawater injection system during a backwash sequence carried out on one of the ultrafiltration units. Thus, the average flowrate set points of each ultrafiltration unit 3 is distributed to all closed loop operational set points automatically by the controller, applying the formula of average flowrate being determined as boosting pump flow divided by the number (N) of active ultrafiltration units.

The control method and system as disclosed provides significant advantages such as: Less dependability on a human operator; Controllable and balanced injection of treated and pure seawater; Overflux/influx of seawater can be prevented; System degradation can be monitored from recorded data used in the operation control; Condition monitoring and diagnostics can be applied by monitoring of transmembrane pressure, valves and pumps performance such as pump vibration and barrier fluid consumption, etc.

From the above specification and drawings a skilled person will realize that modifications can be made without departing from the essentials of the invention as defined in the accompanying claims.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for controlling the operation of a seawater injection system wherein the system comprises at least one water treatment line in which seawater is forced through one or more coarse filtration unit(s), ultrafiltration unit(s) and at least one of a reverse osmosis unit or a nanofiltration unit to a water injection pump, and wherein the flowrate required to create differential pressure across membrane(s) of the ultrafiltration unit(s) is obtained by a boosting pump, the control method comprising a controller “C” implemented operation control by which the outlet pressure and flow of the boosting pump is adjusted automatically such that an average flowrate through the ultrafiltration units is maintained and determined as boosting pump flow divided by the number of active ultrafiltration units.

2. The control method of claim 1, wherein a proportional-integral-derivative control mechanism is applied and executed in the controller “C” for regulation of the output flow/pressure from any flow regulating unit in the seawater injection system, including but not limited to the boosting pump, the water injection pump 9 and valves.

3. The control method of claim 1, wherein the demand for backwash of membranes is checked in a closed control loop and a backwash sequence of limited duration is generated on each ultrafiltration unit if backwash is required.

4. The control method of claim 3, further comprising:
starting seawater filtration units and boosting pump in manual mode,
checking backwash conditions, and if backwash conditions are met, and
transferring seawater filtration units and boosting pump into auto mode applying a PID control mechanism to maintain flowrate and pressure in the boosting pump.

5. The control method of claim 4, further comprising
starting the water injection pump in manual mode,
checking injection water quality, and if the quality of injection water is met, and
transferring injection pump into auto mode applying a PID control mechanism to maintain flowrate and pressure in the injection pump.

6. The control method of claim 5, wherein if injection water quality is not met, mixing water from the nanofiltration unit into the flow from the reverse osmosis unit.

7. The control method of claim 1, wherein the PID control mechanism (18) is applied to all adjustable flow regulating valves in the seawater injection system.

8. A control system for a seawater injection system comprising at least one water treatment line in which seawater is forced through one or more coarse filtration unit(s), ultrafiltration units and at least one of a reverse osmosis unit or a nanofiltration unit to a water injection pump, and wherein the flowrate required to create differential pressure across membrane(s) of the ultrafiltration units is obtained by a boosting pump, the control system comprising the units and pumps of the seawater injection system are electronically integrated in a controller “C” implemented operation control by which the outlet pressure and flow of the boosting pump is automatically adjusted such that an average flowrate through the ultrafiltration units is maintained and determined as boosting pump flow divided by the number of active ultrafiltration units.

9. The control system of claim 8, wherein the controller “C” is arranged for execution of a PID control mechanism for regulation of the output flow/pressure from at least one of the boosting pump, the water injection pump and valves.

10. The control system of claim 8, wherein the operation control comprises
a closed control loop for checking backwash conditions,
a closed control loop applying a PID control mechanism to regulate flowrate/pressure in the boosting pump, and
a closed control loop applying a PID control mechanism to regulate flowrate and pressure in the injection pump.

11. The control system of claim 8, wherein PID control mechanism is applied to all adjustable flow regulating valves in the seawater injection system.

12. The control system of claim 8, wherein the controller “C” implemented operation control is integrated in a control module that controls the position of flow control valves in seawater filtration units as well as power supply to pumps in response to detected flow and/or temperature and/or pressure and/or water quality in the water flow through the seawater treatment line(s).

13. The control system of claim 12, wherein the controller “C” is part of a master control station located topside, or is a subsea control module and/or subsea electronic module communicating with the master control station via an umbilical.

14. The control system of claim 8, further comprising a computer based application to record the system component's performance stored in a memory wherein operational conditions and control measures are continuously recorded as historical data to provide a basis for logic/rules to be applied to compare and evaluate the real-time data with ideal conditions and to make decision for diagnosis and maintenance.
